(19) United States
(12) Patent Application Publication
(10) Pub. No.: US 2016/0312795 A1
(43) Pub. Date: Oct. 27, 2016

(54) COMPOSITE FAN INLET BLADE CONTAINMENT

(71) Applicant: GENERAL ELECTRIC COMPANY, Schenectady, NY (US)

(72) Inventor: David William CRALL, Loveland, OH (US)

(21) Appl. No.: 15/105,212

(22) PCT Filed: Nov. 24, 2014
(86) PCT No.: PCT/US2014/067066

§ 371 Date: Jun. 16, 2016

Related U.S. Application Data
(60) Provisional application No. 61/916,837, filed on Dec. 17, 2013.

(51) Int. Cl. F04D 29/52; B64D 33/02; B64D 29/00; F04D 29/02; F04D 29/32

(52) U.S. Cl. CPC F04D 29/526; F04D 29/023; F04D 29/325; B64D 29/00; B64D 33/02

(57) ABSTRACT

A ribbed composite shell includes an annular grid of relatively thick crack arresting ribs embedded in a relatively thin annular shell and relatively thin panels in thin annular shell between arresting ribs wherein each of panels are completely surrounded by a set of relatively thick adjoining ones of ribs. A shell forward flange may extend radially inwardly from thin annular shell. Arresting ribs may include radially stacked layers of strips between radially stacked annular layers of shell. Annular grid may include a rectangular grid pattern, a diamond grid pattern, or a hexagonal grid pattern. A nacelle inlet may have the ribbed composite shell within one or both of radially spaced apart composite inner and outer skins of an inner barrel. Nacelle inlet may be part of attached to a fan casing and axially disposed forward of fan blades circumscribed by the casing. The inlet may be on an engine nacelle.

### BACKGROUND

### TECHNICAL FIELD

Embodiments of the present invention relate generally to gas turbine engine fan inlets and, more particularly, to fan blade containment in the inlets for containing blade fragments ejected from damaged fan blades.

Aircraft gas turbine engines operate in various conditions and foreign objects may be ingested into the engine. During operation of the engine and, in particular, during movement of an aircraft powered by the engine, the fan blades may be impacted and damaged by foreign objects such as, for example, birds or debris picked up on a runway. Impacts on the blades may damage the blades and result in blade fragments or entire blades being dislodged and flying radially outward at relatively high velocity.

To limit or minimize consequential damage, some known engines include a metallic casing shell to facilitate increasing a radial and an axial stiffness of the engine, and to facilitate reducing stresses near the engine casing penetration. However, casing shells are typically fabricated from a metallic material which results in an increased weight of the engine and, therefore, the airframe. To overcome the increased weight, composite fan casings for a gas turbine engine have been developed.

Some containment structures have been effective in engines to provide the necessary containment of blade fragments. Large engines with high-bypass ratios have revealed blade failure modes in which fan blade fragments have been found to be thrown radially outward and axially forward of the fan casing striking an inlet area of a nacelle surrounding the engine. The blade fragments may have sufficiently high velocities resulting in high energy impacts on the inlet causing damage to the inlet which may be made at least in part of composite materials.

These impacts may be sufficient to cause collapse of an acoustic honeycomb liner by compression of the honeycomb cell structure. Blade fragments may then exit tangentially through the inlet and, if the aircraft is in flight, perhaps result in damage to the aircraft. A second blade containment structure may be positioned axially forward of the fan casing within an engine nacelle. The second containment structure may include an inner liner of noise absorbing material, such as honeycomb paneling, and a ring of titanium material having axially oriented stiffeners for controlling bending upon impact by a broken blade or blade fragment. The ring may be formed as a plurality of arcuate segments having edges adapted for joining with adjacent segments to form a complete ring. A flange may be attached to an aft edge of the ring and used to connect the ring to the fan casing. A forward edge of the ring may have an integrally formed flange for attaching the ring to a support member within the nacelle. The position of the second blade containment structure is such that blades or blade fragments ejected forward of a blade rotation path are captured by the ring and honeycomb liner, thus, preventing axial projection of the blade fragments out of the nacelle.

In an embodiment, it may be beneficial to have a light-weight engine and nacelle so blade-out containment systems may incorporate composite materials. If the inlet is made of a composite, damage from a blade-out event can result in fiber breakage and delamination that can further propagate and cause additional secondary failures during the subsequent coast down and windmilling phases of the engine after the event.

It may also be beneficial to have a fan inlet blade-out or fan blade composite containment system operable for limiting or containing the damage caused by blade fragments ejected forward of a fan casing surrounding the fan.

### BRIEF DESCRIPTION

A ribbed composite shell 110 includes an annular grid 112 of relatively thick crack arresting ribs 114 embedded in a relatively thin annular shell 120, relatively thin panels 118 in the thin annular shell 120 between the arresting ribs 114, and each of the panels 118 completely surrounded by a set 122 of relatively thick adjoining ribs 116 of the relatively thick crack arresting ribs 114.

A shell forward flange 54 may extend radially inwardly from the thin annular shell 120 an axial flange extension 56 may extend axially from the shell forward flange 54.

The arresting ribs 114 may include radially stacked layers of strips 126 between radially stacked annular layers 128.

The annular grid 112 may be circumscribed about an axial centerline axis 30 and each of the panels 118 may be surrounded at least in part by adjoining first and second ribs 102, 104. The crack arresting ribs 114 may be arranged in one of the following grid patterns 136: a rectangular grid pattern 138 wherein the adjoining first ribs 102 running axially 140and the adjoining second ribs 104 running circumferentially 142 relative to the axial centerline axis 30; a diamond grid pattern 148 wherein the adjoining first ribs 102 running axially 140 and circumferentially 142 clockwise and the adjoining second ribs 104 running axially 140 and circumferentially 142 counter-clockwise relative to the axial centerline axis 30; and a hexagonal grid pattern 158 wherein the adjoining first ribs 102 running axially 140, the adjoining second ribs 104 running axially 140 and circumferentially 142 clockwise, and adjoining third ribs 106 running axially 140 and circumferentially 142 counter-clockwise relative to the axial centerline axis 30.

The ribbed composite shell 110 may include the annular grid 112 of crack arresting ribs 114 disposed only in an axially extending portion 92 of the ribbed composite shell (110 and the axially extending portion 92 may be at or near an aft end 94 of the ribbed composite shell 110.

A nacelle inlet 25 includes a rounded annular nose lip section 48 radially disposed between radially spaced apart annular inner and outer barrels 40, 42, the inner barrel 40includes radially spaced apart composite inner and outer skins 60, 62, and at least one of the inner and outer skins 60, 62 has a ribbed composite shell 110. The ribbed composite shell 110 includes an annular grid 112 of relatively thick crack arresting ribs 114 embedded in a relatively thin annular shell 120, relatively thin panels 118 in the thin annular shell 120 between the arresting ribs 114, and each of the panels 118 completely surrounded by a set 122 of relatively thick adjoining ribs 116 of the relatively thick crack arresting ribs 114. A honeycomb core 63 may be sandwiched between the inner and outer skins 60, 62.

An aircraft gas turbine engine assembly includes an aircraft gas turbine engine 10 having a fan assembly 12 with a plurality of radially outwardly extending fan blades 18 rotatable about a longitudinally extending axial centerline axis 30, the engine 10 mounted within a nacelle 32 connected to a fan casing 16 of the engine 10, the fan casing 16 circumscribed about the fan blades 18, and a nacelle inlet 25 including a rounded annular nose lip section 48 radially disposed between radially spaced apart annular inner and outer barrels 40, 42 axially disposed forward of the fan casing 16 and the fan blades 18. The inner barrel 40 includes radially spaced apart composite inner and outer skins 60, 62 and at least one of the inner and outer skins 60, 62 has a ribbed composite shell 110 including an annular grid 112 of relatively thick crack arresting ribs 114 embedded in a relatively thin annular shell 120. Relatively thin panels 118 are in the thin annular shell 120 between the arresting ribs 114, and each of the panels 118 is completely surrounded by a set 122 of relatively thick adjoining ribs 116 of the relatively thick crack arresting ribs 114.

### BRIEF DESCRIPTION OF THE DRAWINGS

FIG. 1 is schematic illustration of a gas turbine engine including a composite fan inlet including a ribbed composite shell with crack arresting ribs for blade out containment.

FIG. 2 is an enlarged cross-sectional illustration of the composite fan inlet illustrated in FIG. 1.

FIG. 3 is a schematic illustration of a rectangular grid pattern of the crack arresting ribs in the composite fan inlet illustrated in FIG. 2.

FIG. 4 is a schematic illustration of a diamond grid pattern of the crack arresting ribs in the composite fan inlet illustrated in FIG. 2.

FIG. 5 is a schematic illustration of a hexagonal grid pattern of the crack arresting ribs in the composite fan inlet illustrated in FIG. 2.

FIG. 6 is a schematic cross-sectional illustration of layers and a lay up of the composite plies used to form ribbed composite shell with crack arresting ribs illustrated in FIG. 2.

### DETAILED DESCRIPTION

A composite fan inlet casing for an aircraft gas turbine engine is described below in detail. The composite casing includes an inner composite barrel with crack arresting ribs. The crack arresting ribs allows the composite casing to resist crack propagation under impact loading. The inner barrel of the composite casing is typically made of circumferentially arranged panels so that when the inlet becomes damaged by fan blade fragments, the panels between the ribs can be punched out, but the damage is contained within a few panels. During impact, kinetic energy is dissipated by delamination of braided layers which then capture and contain the impact objects.

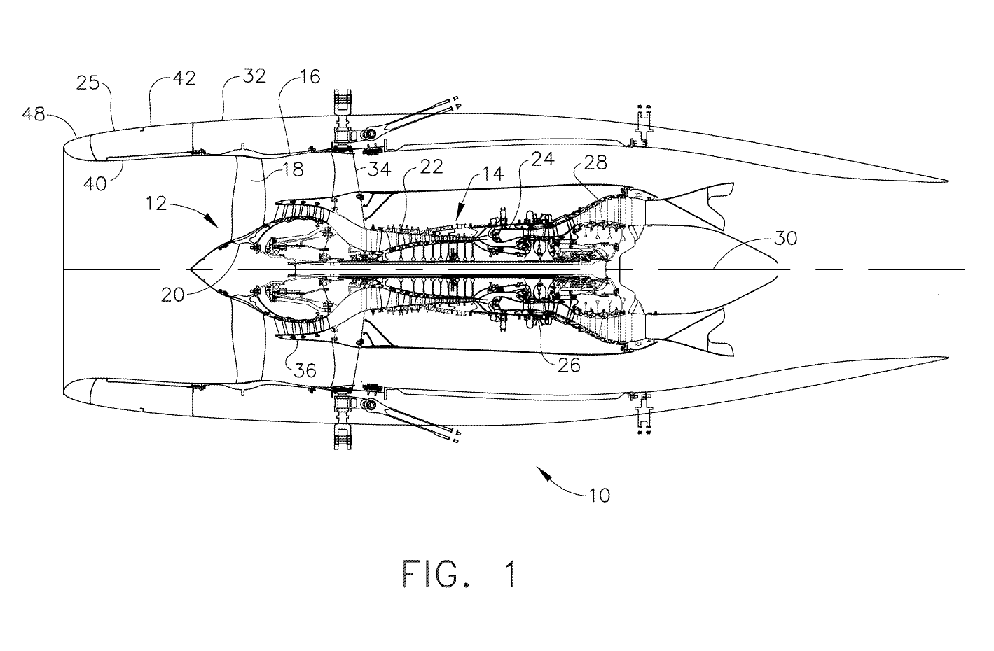

Illustrated in FIG. 1 is one exemplary embodiment of an aircraft gas turbine engine 10 including a fan assembly 12 and a core engine 14. The fan assembly 12 includes a fan casing 16 surrounding an array of fan blades 18 extending radially outwardly from a rotor 20. The core engine 14 includes a high-pressure compressor 22, a combustor 24, a high pressure turbine 26. A low pressure turbine 28 drives the fan blades 18.

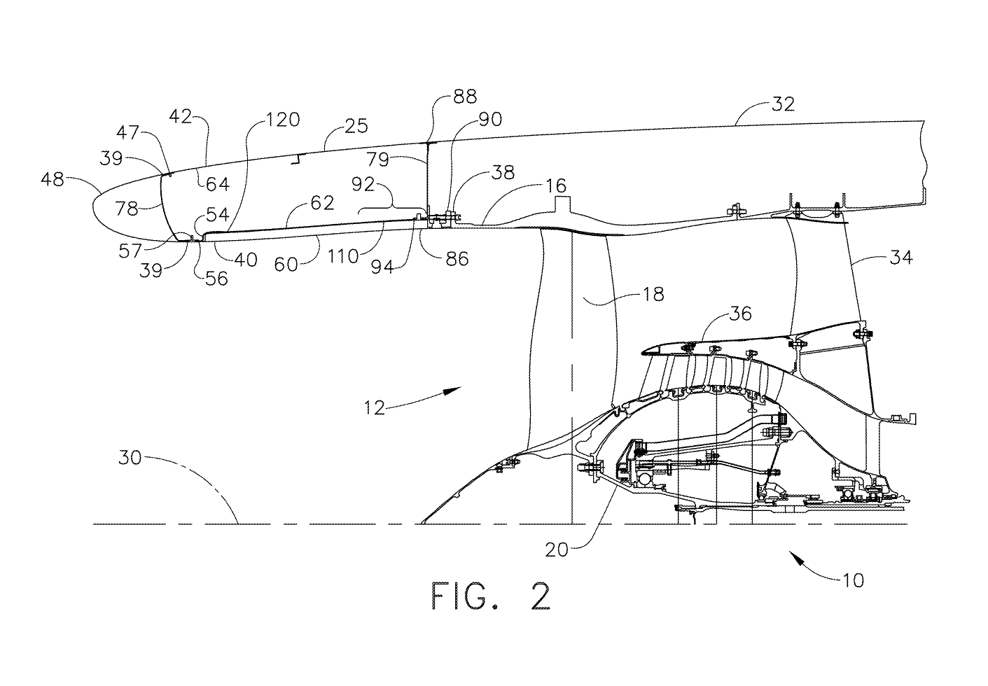

Referring to FIGS. 1 and 2, the fan assembly 12 is rotatable about a longitudinally extending axial centerline axis 30. The engine 10 is mounted within a nacelle 32 that is connected to a fan casing 16 of the engine 10. The fan casing 16 is circumscribed about the fan blades 18. The fan casing 16 supports the fan assembly 12 through a plurality of circumferentially spaced struts 34 and through a booster fan assembly 36. The nacelle 32 includes an annular composite inlet 25 attached to a forward casing flange 38 on the fan casing 16 by a plurality of circumferentially spaced fasteners, such as bolts or the like. The inlet 25 typically includes radially spaced apart annular inner and outer barrels 40, 42. A rounded annular nose lip section 48 is radially disposed between the inner and outer barrels 40, 42. Air entering the engine 10 passes through the inlet 25.

The inner barrel 40 includes radially spaced apart composite inner and outer skins 60, 62. A honeycomb core 63 may be sandwiched between the inner and outer skins 60, 62. The outer barrel 42 may be a single composite skin 64 as illustrated herein. A forward edge 39 of the outer barrel 42 may be connected to the nose lip section 48 by a first plurality of circumferentially spaced fasteners 47, such as rivets, or the like. Similarly, a forward edge 39 of the inner barrel 40 may be connected to the nose lip section 48 by a second plurality of circumferentially spaced fasteners 57, such as rivets, bolts, or the like. The fasteners 47, 57 secure the components of the inlet 25 together and transmit loads between fastened components.

A forward bulkhead 78 extends between radially spaced apart outer and inner annular walls 80, 82 of the nose lip section 48. An aft bulkhead 79 connect radially spaced apart inner and outer barrel aft ends 86, 88 of the inner and outer barrels 40, 42. The forward and aft bulkheads 78, 79 contribute to the rigidity and strength of the inlet 25. An aft flange 90 on the inner barrel 40 may be used to connect the inlet 25 to the forward casing flange 38 of the fan casing 16. The composite inner barrel 40 directly supports the outer barrel 42 and nose lip section 48. The weight of the inlet 25 and external loads borne by the inlet 25 are transferred to the fan casing 16 through the inner barrel 40. Therefore, the composite inner barrel 40 of a typical nacelle's inlet 25 can substantially contribute to the overall rigidity, strength and stability of the inlet 25 of the nacelle 32.

A “blade-out event” arises when a fan blade or portion thereof is accidentally released from a rotor of a high-bypass turbofan engine. When suddenly released during flight, a fan blade can impact a surrounding fan case with substantial force, and resulting loads on the fan case can be transferred to surrounding structures, such as to the inlet of a surrounding nacelle 32. These loads can cause substantial damage to the nacelle inlet, including damage to the adjoining inner barrel 40. In addition, or alternatively, a released fan blade or portion thereof may directly impact a portion of an adjacent inner barrel 40, thereby, causing direct damage to the inner barrel 40. Because the inner barrel 40 directly supports the inlet 25 on the fan casing 16, including the outer barrel 42 and nose lip section 48, damage to the inner barrel 40 can compromise the structural integrity and stability of the nacelle 32, and may negatively affect the fly-home capability of an aircraft.

A blade-out event also causes the rotational balance of an engine's fan blades 18 to be lost. After a damaged engine 10 is typically shut down following a blade-out event, airflow impinging on the unbalanced fan blades 18 can cause the fan blades 18 to rapidly spin or “windmill.” Such wind-milling of an unbalanced fan 18 can exert substantial vibrational loads on the engine 10 and fan casing 16, and at least some of these loads can be transmitted to an attached inlet 25 and inner barrel 40 of the nacelle 32. In addition, following a blade-out event, aerodynamic forces and a suction created by a windmilling fan blade 18 can exert substantial loads on a damaged inlet 25 of the nacelle 32. Such loads can cause substantial deformation of a damaged inlet 25 and can result in unwanted aerodynamic drag. Such loads also can cause cracks or breaks in a damaged composite inner barrel 40 to propagate, further compromising the structural integrity and stability of a damaged inlet 25 of a nacelle 32. This damage may result in fiber breakage and delamination that can further propagate and cause additional secondary failures during the subsequent coast down and windmilling phases after the event. Accordingly, there is a need for a nacelle structure for a turbofan aircraft engine that is capable of maintaining a substantially stable and aerodynamic configuration subsequent to a blade-out event, and which thereby supports an aircraft's fly-home capability following such an incident. In particular, there is a need for a nacelle's inlet structure for a high-bypass turbofan aircraft engine that maintains its structural integrity and a stable aerodynamic configuration even though its composite inner barrel has been substantially damaged due to a blade-out event.

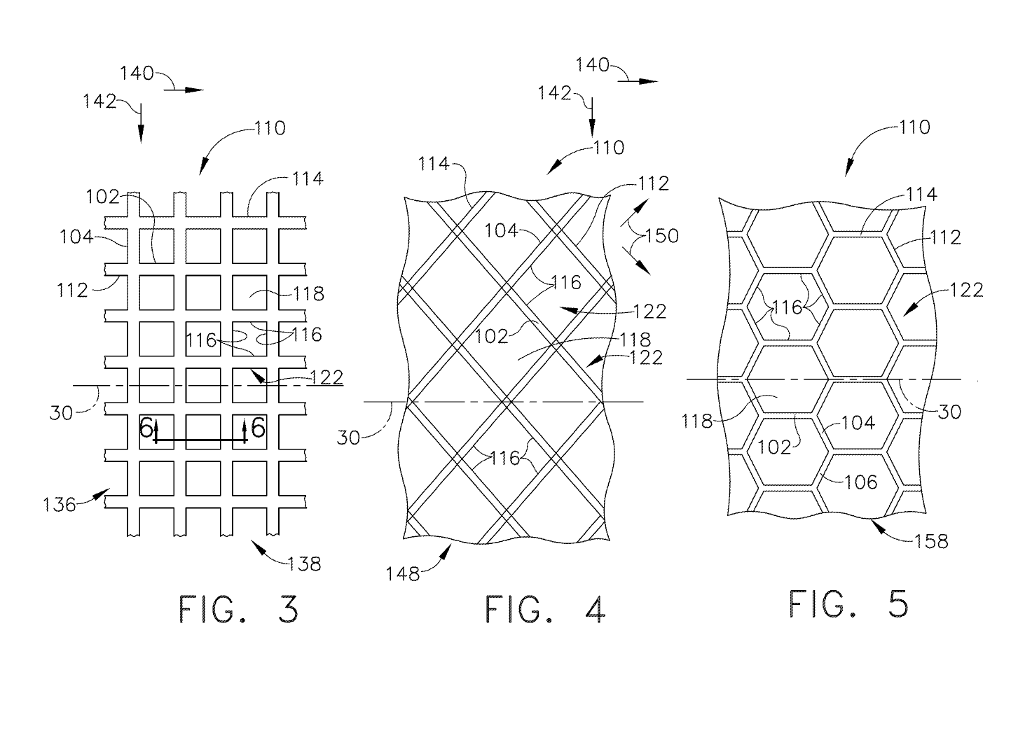

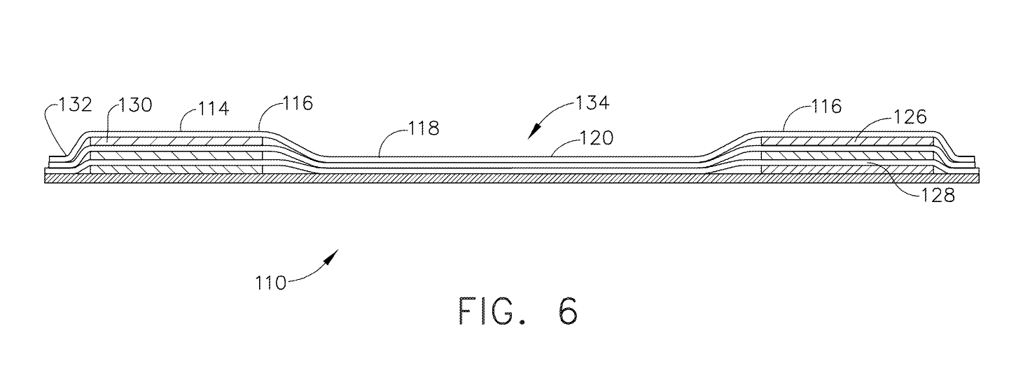

Referring to FIGS. 3 and 6, ribbed composite shells 110 may be used in the composite inner and outer skins 60, 62 of the inner barrel 40 and in the outer barrel 42. Each ribbed composite shell 110 includes an annular grid 112 of relatively thick crack arresting ribs 114 embedded in a relatively thin annular shell 120. The exemplary embodiment of the ribbed composite shell 110 illustrated herein has the annular grid 112 of crack arresting ribs 114 embedded only in an axially extending portion 92 of the ribbed composite shell 110 as illustrated in FIG. 2. A more particular embodiment of ribbed composite shell 110 has the annular grid 112 of crack arresting ribs 114 disposed only in an axially extending portion 92 of the ribbed composite shell 110 at or near an aft end 94 of the ribbed composite shell 110 as illustrated in FIG. 2.

Referring to FIGS. 3-5, each ribbed composite shell 110 includes relatively thin panels 118 completely surrounded by sets 122 of relatively thick adjoining ribs 116. The adjoining ribs 116 are angled with respect to each other. Referring to FIG. 2, the ribbed composite shell 110 includes a shell forward flange 54 extending radially inwardly from the thin annular shell 120. An axial flange extension 56 extending axially from the shell forward flange 54 is used to attach the ribbed composite shell 110 to the inner barrel 40.

Referring to FIGS. 3-6, the ribbed composite shell 110 is designed to contain the damage within the thin shell portions or panels 118 between the ribs 114 of the ribbed composite shells 110. The ribs 114 radially extend entirely through the ribbed composite shells 110. The ribs 114 may be formed by inserting thin or narrow strips or narrow composite plies 130 between wide composite plies 132 during the lay up of a prepreg 134 of the ribbed composite shells 110 as illustrated in FIG. 6. A lay up of the narrow composite plies 130 interspersed between the annular wide composite plies 132 form the ribs 114 and the panels 118 between the ribs 114. The ribbed composite shell 110 includes radially stacked layers of strips 126 between radially stacked annular layers 128 corresponding to the narrow composite plies 130 interspersed between the annular wide composite plies 132.

Composite plies used to build the prepreg may be made of a type of fiber textile formed and held together by a matrix. Fiber textiles may include a tape, a cloth, a braid, a Jacquard weave, or a satin. A matrix may include epoxy, Bismolyamid, or PMR15. Fibers may include carbon, kevlar or other aramids, or glass.

The grid 112 of relatively thick crack arresting ribs 114 may have various grid patterns 136, examples of which are illustrated in FIGS. 3-5. A rectangular grid pattern 138 illustrated in FIG. 3 includes adjoining first ribs 102 running axially 140 and adjoining second ribs 104 running circumferentially 142 relative to the axial centerline axis 30. A diamond grid pattern 148 illustrated in FIG. 4 includes adjoining ribs 116 running diagonally 150 relative to the axial centerline axis 30. Each set 122 of the adjoining ribs 116 in the diamond grid pattern 148 include a first rib 102 running axially and circumferentially clockwise and a second rib 104 running axially and circumferentially counter-clockwise. A hexagonal grid pattern 158 illustrated in FIG. 5 includes ribs 114 arranged in hexagons 160 and include first ribs 102 running axially, second ribs 104 running axially and circumferentially clockwise, and third ribs 106 running axially and circumferentially counter-clockwise. The ribs 114 in all of the patterns circumscribe panels 118 between the ribs 114.

While there have been described herein what are considered to be preferred and exemplary embodiments of the present invention, other modifications of the embodiments shall be apparent to those skilled in the art from the teachings herein and, it is therefore, desired to be secured in the appended claims all such modifications as fall within the true spirit and scope of the embodiments. Accordingly, what is desired to be secured by Letters Patent of the United States are the embodiments of the present invention as defined and differentiated in the following claims.

What is claimed is:

1. A ribbed composite shell comprising:
an annular grid of relatively thick crack arresting ribs embedded in a relatively thin annular shell,
relatively thin panels in the thin annular shell between the arresting ribs, and
a set of relatively thick adjoining ribs, wherein each of the relatively thin panels is completely surrounded by the set of relatively thick adjoining ribs of the relatively thick crack arresting ribs.

2. The ribbed composite shell in accordance with claim 1, further comprising a shell forward flange extending radially inwardly from the thin annular shell.

3. The ribbed composite shell in accordance with claim 2, further comprising an axial flange extension extending axially from the shell forward flange.

4. The ribbed composite shell in accordance with claim 1, further comprising the arresting ribs including radially stacked layers of strips between radially stacked annular layers.

5. The ribbed composite shell in accordance with claim 4, further comprising a shell forward flange extending radially inwardly from the thin annular shell and an axial flange extension extending axially from the shell forward flange.

6. The ribbed composite shell in accordance with claim 1 further comprising:
the annular grid circumscribed about an axial centerline axis;
each of the panels surrounded at least in part by adjoining first and second ribs;
the crack arresting ribs arranged in a grid pattern chosen from the following grid patterns;
a rectangular grid pattern including the adjoining first ribs running axially and the adjoining second ribs running circumferentially relative to the axial centerline axis;
a diamond grid pattern including the adjoining first ribs running axially and circumferentially clockwise and the adjoining second ribs running axially and circumferentially counter-clockwise relative to the axial centerline axis; and
a hexagonal grid pattern including the adjoining first ribs running axially, the adjoining second ribs running axially and circumferentially clockwise, and adjoining third ribs running axially and circumferentially counter-clockwise relative to the axial centerline axis.

7. The ribbed composite shell in accordance with claim 6, further comprising a shell forward flange extending radially inwardly from the thin annular shell.

8. The ribbed composite shell in accordance with claim 7, further comprising an axial flange extension extending axially from the shell forward flange.

9. The ribbed composite shell in accordance with claim 6, further comprising the arresting ribs including radially stacked layers of strips between radially stacked annular layers.

10. The ribbed composite shell in accordance with claim 9, further comprising a shell forward flange extending radially inwardly from the thin annular shell.

11. The ribbed composite shell in accordance with claim 10, further comprising an axial flange extension extending axially from the shell forward flange.

12. The ribbed composite shell in accordance with claim 9, further comprising the annular grid of crack arresting ribs disposed only in an axially extending portion of the ribbed composite shell.

13. The ribbed composite shell in accordance with claim 12 further comprising the axially extending portion at or near an aft end of the ribbed composite shell.

14. A nacelle inlet comprising:
a rounded annular nose lip section radially disposed between radially spaced apart annular inner and outer barrels,
the inner barrel including radially spaced apart composite inner and outer skins, at least one of the inner and outer skins having a ribbed composite shell including an annular grid of relatively thick crack arresting ribs embedded in a relatively thin annular shell,
relatively thin panels in the thin annular shell between the arresting ribs, and each of the panels completely surrounded by a set of relatively thick adjoining ribs of the relatively thick crack arresting ribs.

15. The nacelle inlet in accordance with claim 14, further comprising the outer skin having the ribbed composite shell and a shell forward flange extending radially inwardly from the thin annular shell.

16. The nacelle inlet in accordance with claim 15, further comprising an axial flange extension extending axially from the shell forward flange.

17. The nacelle inlet in accordance with claim 14, further comprising the arresting ribs including radially stacked layers of strips between radially stacked annular layers.

18. The nacelle inlet in accordance with claim 17, further comprising the annular grid of crack arresting ribs disposed only in an axially extending portion at or near an aft end of the ribbed composite shell.

19. The nacelle inlet in accordance with claim 14, further comprising:
the annular grid circumscribed about an axial centerline axis;
each of the panels surrounded at least in part by adjoining first and second ribs;
the crack arresting ribs arranged in a grid pattern chosen from the following grid patterns;
a rectangular grid pattern including the adjoining first ribs running axially and the adjoining second ribs running circumferentially relative to the axial centerline axis;
a diamond grid pattern including the adjoining first ribs running axially and circumferentially clockwise and the adjoining second ribs running axially and circumferentially counter-clockwise relative to the axial centerline axis; and
a hexagonal grid pattern including the adjoining first ribs running axially, the adjoining second ribs running axially and circumferentially clockwise, and adjoining third ribs running axially and circumferentially counter-clockwise relative to the axial centerline axis.

20. The nacelle inlet in accordance with claim 19, further comprising the arresting ribs including radially stacked layers of strips between radially stacked annular layers.

21. The nacelle inlets in accordance with claim 20, further comprising the annular grid of crack arresting ribs disposed only in an axially extending portion at or near an aft end of the ribbed composite shell.

22. The nacelle inlet in accordance with claim 21, further comprising a honeycomb core sandwiched between the inner and outer skins.

23. An aircraft gas turbine engine assembly comprising:
an aircraft gas turbine engine including a fan assembly including a plurality of radially outwardly extending fan blades rotatable about a longitudinally extending axial centerline axis,
the engine mounted within a nacelle connected to a fan casing of the engine,
the fan casing circumscribed about the fan blades,
a nacelle inlet including a rounded annular nose lip section radially disposed between radially spaced apart annular inner and outer barrels axially disposed forward of the fan casing and the fan blades,
the inner barrel including radially spaced apart composite inner and outer skins,
at least one of the inner and outer skins having a ribbed composite shell including an annular grid of relatively thick crack arresting ribs embedded in a relatively thin annular shell,
relatively thin panels in the thin annular shell between the arresting ribs, and
each of the panels completely surrounded by a set of relatively thick adjoining ribs of the relatively thick crack arresting ribs.

24. The aircraft gas turbine engine assembly in accordance with claim 23, further comprising the outer skin having the ribbed composite shell and a shell forward flange extending radially inwardly from the thin annular shell.

25. The aircraft gas turbine engine assembly in accordance with claim 23, further comprising the arresting ribs including radially stacked layers of strips between radially stacked annular layers.

26. The aircraft gas turbine engine assembly in accordance with claim 25, further comprising the annular grid of crack arresting ribs disposed only in an axially extending portion at or near an aft end of the ribbed composite shell.

27. The aircraft gas turbine engine assembly in accordance with claim 23, further comprising:
the annular grid circumscribed about an axial centerline axis;
each of the panels surrounded at least in part by adjoining first and second ribs;
the crack arresting ribs arranged in a grid pattern chosen from the following grid patterns;
a rectangular grid pattern including the adjoining first ribs running axially and the adjoining second ribs running circumferentially relative to the axial centerline axis;
a diamond grid pattern including the adjoining first ribs running axially and circumferentially clockwise and the adjoining second ribs running axially and circumferentially counter-clockwise relative to the axial centerline axis; and
a hexagonal grid pattern including the adjoining first ribs running axially, the adjoining second ribs running axially and circumferentially clockwise, and adjoining third ribs running axially and circumferentially counter-clockwise relative to the axial centerline axis.

28. The aircraft gas turbine engine assembly in accordance with claim 27, further comprising the arresting ribs including radially stacked layers of strips between radially stacked annular layers.

29. The aircraft gas turbine engine assembly in accordance with claim 28, further comprising the annular grid of crack arresting ribs disposed only in an axially extending portion at or near an aft end of the ribbed composite shell.

30. The aircraft gas turbine engine assembly in accordance with claim 29, further comprising a honeycomb core sandwiched between the inner and outer skins.
